(19) United States
(12) Patent Application Publication
(10) Pub. No.: US 2026/0278661 A1
(43) Pub. Date: Sep. 17, 2026

(54) SYSTEM AND METHOD OF GENERATING A RECOMMENDATION OF A PRODUCT OR SERVICE BASED ON A TRAVEL DESTINATION

(71) Applicant: Thomas Kuhl, West St. Paul, MN (US)

(72) Inventor: Thomas Kuhl, West St. Paul, MN (US)

(21) Appl. No.: 19/678,372

(22) Filed: May 15, 2026

Related U.S. Application Data
(63) Continuation-in-part of application No. PCT/IB2024/061477, filed on Nov. 17, 2024.
(60) Provisional application No. 63/600,300, filed on Nov. 17, 2023.

(51) Int. Cl. G06Q 30/0601

(52) U.S. Cl. CPC G06Q 30/06314; G06Q 30/06312

(57) ABSTRACT

Systems and methods are provided for determining traveler information, details of upcoming travel, and wants and needs of the traveler and using the information to project, predict, and recommend products and services the customer may want or need before and during the travel. The system also recommends both online and physical vendors and service providers from whom the traveler may purchase goods or services. The system orients these recommendations to vendors and providers locate at the airport or other departure point and other locations convenient to the traveler. The system provides travelers with an online recommendation tool functioning as a user front end that promotes the traveler to enter all the necessary information and receive recommendations.

### CROSS-REFERENCE TO RELATED PATENT APPLICATIONS

The present disclosure is a continuation-in-part of International Patent Application No. PCT/IB2024/061477, filed Nov. 17, 2024, which claims the benefit and priority to U.S. Provisional Patent Application No. 63/600,300, filed Nov. 17, 2023, the contents of which are incorporated herein by reference in their entireties.

### FIELD OF DISCLOSURE

The present disclosure is in the field of travel assistance. More particularly, the present disclosure provides systems and computer-implemented methods of learning about a traveler and his/her travel plan details, learning about and projecting the traveler's needs and wants, and based on this information and projections, providing recommendations for purchases of products of services before and during the traveler's trip and suggesting vendors related thereto.

### BACKGROUND

As air travel becomes affordable to the growing middle-class populations around the world, many more millions of people are expected to be traveling by air in coming years. Similarly, as developing countries become more mobile and focus on infrastructure, they are expected to build more highways and rail networks. This will enable larger segments of the global population in developing countries and elsewhere and in lower income brackets to travel.

In recent years, airports and other travel facilities have transitioned from mere departure and arrival points to traveler experience centers. Some recently built or renovated airports resemble luxury shopping malls with large food courts and high-quality restaurants. Luxury products are prominently displayed for sale along with books, expensive souvenirs, and travel goods such as comfort and sleep aids.

Airport operators observed that travelers frequently have readily accessible disposable income, and may be in a mindset to spend, particularly if they are traveling on vacation, and have time on their hands as they are waiting for their flights. Because of the recent pandemic, travelers are told to arrive even earlier for flights, which often means even more available time for them at the airport to shop.

While some travelers arrive at the airport fully prepared for their trips, many forget essential items that will be needed. Other travelers do not take into consideration future needs associated with the environment they are traveling to.

### BRIEF DESCRIPTION OF THE FIGURES

FIG. 1 is a flowchart of actions of systems provided herein in accordance with an embodiment of the present disclosure.

FIG. 2 is a flowchart of actions of systems provided herein in accordance with an embodiment of the present disclosure.

FIG. 3 is a flowchart of actions of systems provided herein in accordance with an embodiment of the present disclosure.

FIG. 4 is a flowchart of actions of systems provided herein in accordance with an embodiment of the present disclosure.

FIG. 5 is a flowchart of actions of systems provided herein in accordance with an embodiment of the present disclosure.

FIG. 6 is a flowchart of actions of systems provided herein in accordance with an embodiment of the present disclosure.

FIG. 7 is a flowchart of an example method of generating a recommendation of a product or service based on a travel destination according to an embodiment of the present disclosure.

FIG. 8 is a flowchart of an example method of generating a recommendation of a product or service based on a travel destination according to an embodiment of the present disclosure.

FIG. 9 is a block diagram of a data-processing system according to an exemplary embodiment.

### DETAILED DESCRIPTION

Systems and methods provided herein are directed to assisting travelers to better understand their present and future travel needs and provide recommendations and means for travelers to purchase recommended products and services for their trip. Systems gather information about a traveler, the traveler's upcoming trip, and information about the traveler's destination to predict what the traveler may need during their trip. The system makes recommendations for pre-travel purchases and provides information about vendors and service providers to complete their purchases.

Systems and methods provide the traveler an online recommendation tool that the traveler accesses by a graphical user interface. The traveler enters his/her identifying information, his/her wants and needs, and his/her travel details. The system then generates recommendations of goods and services the traveler may purchase before and during an upcoming trip. Some recommendations are the result of predictions made by the system based on the traveler's present entries as well as stored information about the traveler.

The traveler is provided with the means to make such purchases comprising suggestions of physical and online retailers from whom the traveler may make purchases. As the traveler will likely be departing from an airport or other embarkation point, the system may direct the traveler to retailers and service providers at or near the airport with the aid of maps and directions.

The traveler accesses the online recommendation tool provided herein that may serve as a “front end” for users seeking recommendations and other services from the system. The traveler enters his/her name, age, gender, and location. The traveler may enter items that he/she absolutely needs such as personal toiletries and items that he/she wants such as books. The traveler also enters travel information including travel dates and airline flight information which includes departure points and destination.

Based on this information the system makes recommendations to the traveler about products and services the traveler may need or want for the upcoming trip. The recommendations may be oriented to the types of vendors at the departure and destination airports.

The system considers such factors as the traveler's age, weather at the traveler's departure and destination cities, whether the traveler is traveling on business or pleasure, and if accompanied by a spouse or group or traveling alone. The system also considers how much time is remaining before travel commences. This information may provide indications as to whether the traveler is “in a rush” or not and how this may suggest items the traveler may forget or services needed such as valet parking.

Another factor is distance from the traveler's home or present location to the airport. This information may suggest presenting the traveler with different alternatives for getting to the airport such as limousine or shared ride service.

The system accumulates and stores information about the traveler including the traveler's previous trips. This information may be helpful in predicting the types of wants and needs the customer may have as well as the traveler's habits and interests. The system may access information sources unrelated to travel to find more information about the traveler including demographic, financial, and lifestyle information.

The “system” as described herein includes at least one computer and an application that executes many of the actions described herein. The online recommendation tool that the traveler accesses to enter information and receive feedback may be part of the application or it may be separate.

For purposes of this discussion, the online recommendation tool is incorporated into and controlled by the application. But in many embodiments, the online recommendation tool is technically separate from the application and is not controlled in any way by the application. In such a scenario, the application in an “arm's length manner” receives information from the tool, processes it, and sends feedback to the traveler through the tool or via another manner.

In an embodiment, the online recommendation tool may provide services to other entities separate from a party that owns and operates the system and application provided herein. These other separate entities may include business competitors of the party owning and operating the system such that the online recommendation tool maintains security around the matters it conducts with the system of the present disclosure and with outside parties unrelated to the party that owns and operates the present system.

From the traveler's perspective, the traveler may access the system via the online recommendation tool and make choices via a graphical user interface provided by the tool. Recommendations and other information may be provided by the system back to the traveler via the tool.

In one embodiment, the system uses information about the traveler and his/her destination to provide packing advice and purchase suggestions. In addition to purchase suggestions, the system provides assistance as to the means to make such purchases, such as from vendors located inside the departure airport or from online vendors. The system may also provide information about selected event ticket vendors for events at the traveler's destination.

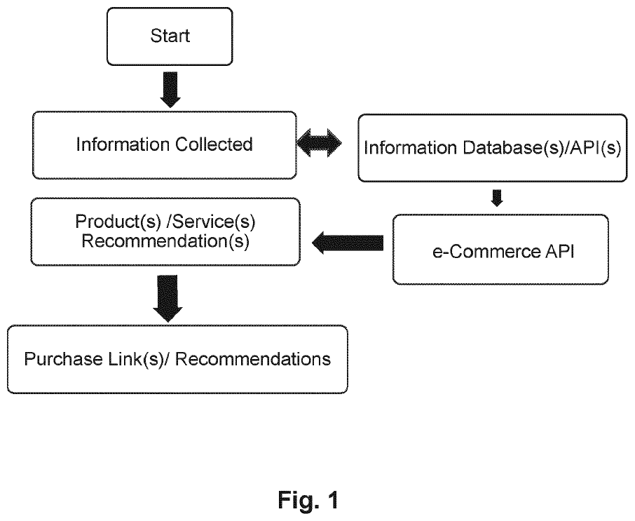

Turning to the figures, FIG. 1 is a flowchart illustrating a basic embodiment of the present disclosure. The system begins by collecting, via the online recommendation tool, information from the traveler such as age, gender, and special needs. The tool also gathers travel information including dates and times of travel, departure and destination airports, and airline flight numbers.

The system may then use databases connected to through an API link, for example an eCommerce API or other means to locate upcoming events and provide recommendations on what items the traveler may want to bring with them or what services they may need before or during their trip. The system may provide the traveler with an app link or website link to locations where products the traveler may need can be purchased and potentially needed services can be obtained by the traveler, either online via an ecommerce platform, in person, or via another means.

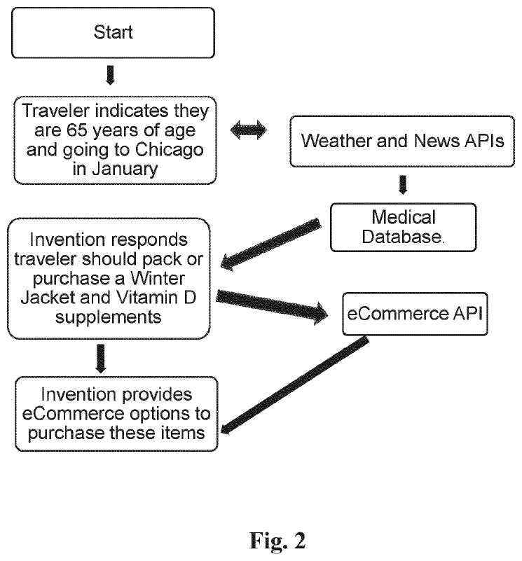

FIG. 2 is a flowchart illustrating an example of how systems and methods provided herein may be applied. FIG. 2 is a flowchart describing a hypothetical traveler who submits that he/she is 65 years of age and will be traveling to Chicago in the month of January. The traveler may submit this information from his/her mobile device after downloading an app with the necessary components of the system including at least a client portion of the online recommendation tool.

The system connects to a weather API and learns that the temperature in January in Chicago is expected to stay below freezing. The system connects to a medical API or database and determines therefrom that a vitamin D deficiency is common among those of advanced age during winter months at higher latitudes. Based at least on this information, the system may suggest packing or purchasing a winter jacket and Vitamin D supplements.

The system may provide links to locations where such products may be purchased. In this instance, the system may direct its attention to the time factor for the traveler. Is the traveler departing in two hours or two weeks? This may cause the system to give the traveler different recommendations as to where the traveler may make purchases for these recommended items and other items needed for the trip. The system may consult medical databases and use eCommerce APIs and may provide eCommerce options to purchase recommended and other items.

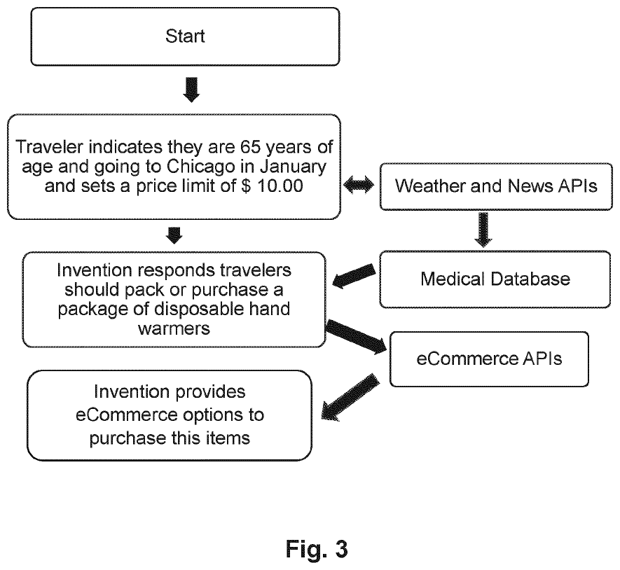

FIG. 3 illustrates a variation of FIG. 2 such that the traveler may choose to limit the results of the output of FIG. 2 to a specific type of product or service and/or limit trait, brand, category, or price of products and/or services. In the example of FIG. 3, the traveler sets a price limit of $10.00. The system in reply suggests the traveler purchase a packet of disposable hand warmers instead of the more expensive winter jacket.

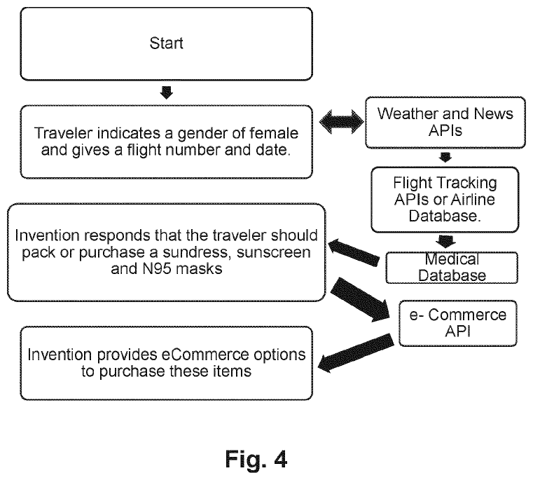

FIG. 4 illustrates another example in which a traveler accesses an Internet web site that provides at least portions of the system or accesses a link to a different web site, much of that different web site executing on a laptop computer. The traveler submits information to the online recommendation tool made available in many embodiments by the system. The submitted information includes the gender of the traveler which is female in the example of FIG. 2, as well as a flight number and date of departure.

The system accesses a flight tracking API or a database for the airline and confirms that the submitted flight number has a destination of Los Angeles and is scheduled for the end of July. Having confirmed this information, the system accesses a weather API or database and observes that the weather is expected to be hot in Los Angeles at the end of July.

The system may also access a news API or database and observe that a wildfire is present in the area. Using the weather information, the system suggests to the traveler to pack or purchase a sundress and sunscreen. The system also uses the news information to suggest that the traveler pack or purchase N95 particle filtration masks. This advice is provided due to a potential for exposure to wildfire smoke. The system links the traveler to retailers where the recommended products may be purchased online, via an eCommerce platform, or in person.

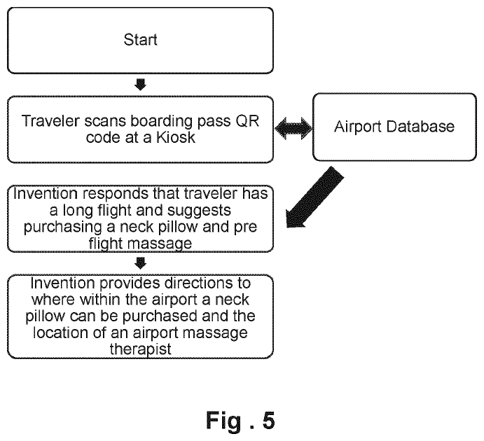

FIG. 5 depicts another example in which a traveler is present at an airport, Los Angeles International Airport in this example, and scans a QR code on his/her boarding pass at a kiosk. The system, which in this embodiment may execute at least partially in a chatbot of the kiosk, determines that the traveler will be departing for Sydney, Australia on a nonstop flight in three hours.

Because of the flight's duration and the traveler's physical confinement in his/her seat, the system suggests that the traveler purchase a neck pillow and get a massage. The system provides directions as to where the neck pillow and the massage may be purchased. The system may provide a map of the airport and of the particular concourse or boarding area wherein the traveler is presently located.

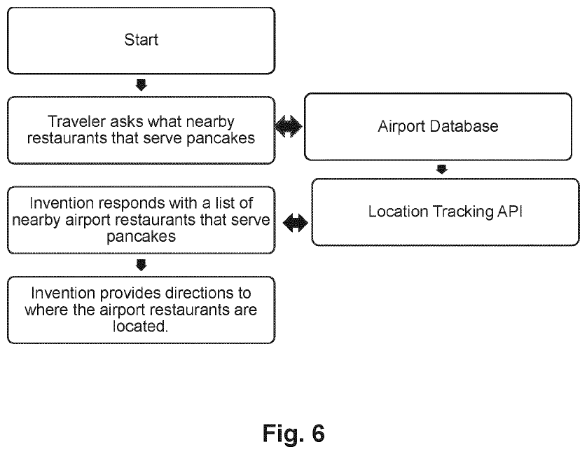

FIG. 6 illustrates yet another example wherein a traveler, prior to or after arriving at an airport, downloads a chatbot that has been created for that specific airport. The traveler downloads the chatbot to his/her mobile device and agrees to allow location tracking.

The traveler then requests the chatbot to advise which nearby restaurants serve pancakes. The system uses a location tracking API to determine the specific area of the airport where the traveler is presently located. The system provides a map and/or walking instructions to the nearest restaurants at the airport that serve pancakes.

In the examples provided above, the system may also have access to previously prepared lists, databases, or links to at least one API listing commonly forgotten items before a traveler departs such as toothpaste or a cellphone charger. The system uses these resources to recommend for the traveler to pack or purchase. The system provides means to locations where these commonly forgotten items may be purchased.

Systems and methods provided herein may also apply to travel not by air but rather by bus or railroad. A traveler may enter information into the online recommendation tool comprising departure point comprising bus station or railroad station, bus line or train number, and arrival points. The system may similarly process the traveler's information and provide recommendations as described above.

In another embodiment, a multi-tenant data processing system is provided comprising at least one business-related application accessible by a plurality of tenants of the system. One such application may be the system as described in detail above which in many embodiments includes the online recommendation tool. Instructions executed by a processor within the system and interactions with travelers and other users are the same as those described in connection with FIG. 1 through FIG. 6 above.

One of the tenants may be the traveler as described above. In this embodiment, the data processing system may include a database stored within or may have access to at least one external and possibly remote database.

The business-related application may have access to at least one enterprise resource planning (ERP), customer relationship management (CRM) or eCommerce application. The business-related application has access to one or more computer software APIs or databases providing data about the traveler's destination or destinations. Information collected or recommendations returned may be done by use of a conversational chatbot.

In yet another embodiment, an apparatus is provided for generating a recommendation for a product or service to a customer. The apparatus comprises a computing device including a processor for executing a set of instructions and an electronic data storage element that stores the instructions.

The service recommendation tool as described above is also at least partially stored in the computing device. The steps described in the discussion above of FIG. 1 through FIG. 6 comprise the set of instructions in this embodiment and are executed on the processor.

The one or more products or services are presented as recommendations to the customer via a graphical user interface associated with the online recommendation tool. Generating the recommendation is based at least in part on the use of a collaborative filtering technique, mechanism, or process.

Embodiments of the present disclosure may be deployed as an Internet web site where the online recommendation tool is effectively the front end for the traveler. The traveler may access the tool from a browser session from a desktop or laptop computer or mobile device. The traveler may access the system via a downloadable app obtained from a mobile device app store. The traveler may access the system from a ChatBot assistant, which itself may be part of a downloadable app, part of a website, or part of a physical kiosk, or may be a combination of any or all of these parts.

Previous conventional solutions may have suggested some aspects provided herein. For example, a conventional solution includes U.S. Pat. No. 10,430,859B2, but a review of this disclosure reveals that it does not use a travel destination as a means for recommending products or services.

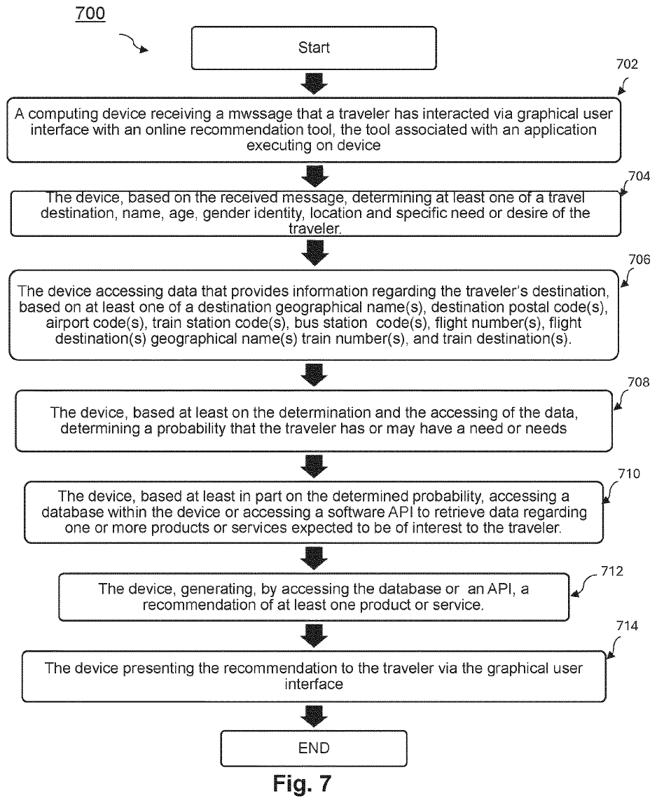

FIG. 7 depicts steps of a method 700 that begins at block 702 with a computing device receiving a message that a traveler has interacted via graphical user interface with an online recommendation tool, the tool associated with an application executing on the device. At block 704, the device, based on the received message, determines at least one of a travel destination, name, age, gender identity, location, and specific need or desire of the traveler.

At block 706, the device accesses data that provides information regarding the traveler's destination, based on at least one destination geographical name(s), destination postal code(s), airport code(s), train station code(s), bus station code(s), flight number(s), flight destination(s) geographical name(s) train number(s), and train destination(s). At block 708, the device, based at least on the determination and the accessing of the data, determines a probability that the traveler has or may have a need or needs.

The method 700 continues at block with 710, with the device, based at least in part on the determined probability, accessing a database within the device or accessing a software API to retrieve data regarding one or more products or services expected to be of interest to the traveler. At block 712, the device generates, by accessing the database or the API, a recommendation of at least one product or service.

At block 714, the device presents the recommendation to the traveler via the graphical user interface. The method 700 thereafter ends.

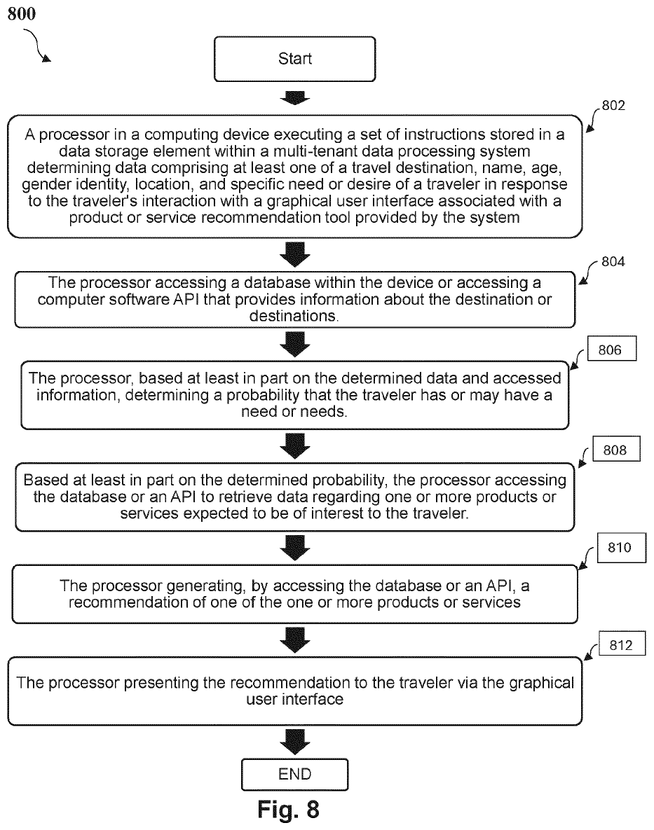

FIG. 8 depicts steps of a method 800 that begins at block 802 with a processor in a computing device executing a set of instructions stored in a data storage element within a multi-tenant data processing system. The processor determines data comprising at least one of a travel destination, name, age, gender identity, location, and specific need or desire of a traveler in response to the traveler's interaction with a graphical user interface associated with a product or service recommendation tool provided by the system. At block 804, the processor accesses a database within the device or accesses a computer software API that provides information about the destination or destinations.

At block 806, the processor, based at least in part on the determined data and accessed information, determines a probability that the traveler has or may have a need or needs. At block 808, based at least in part on the determined probability, the processor accesses the database or an API to retrieve data regarding one or more products or services expected to be of interest to the traveler.

At block 810, the processor generates, by accessing the database or an API, a recommendation of one of the one or more products or services. At block 812, the processor presents the recommendation to the traveler via the graphical user interface.

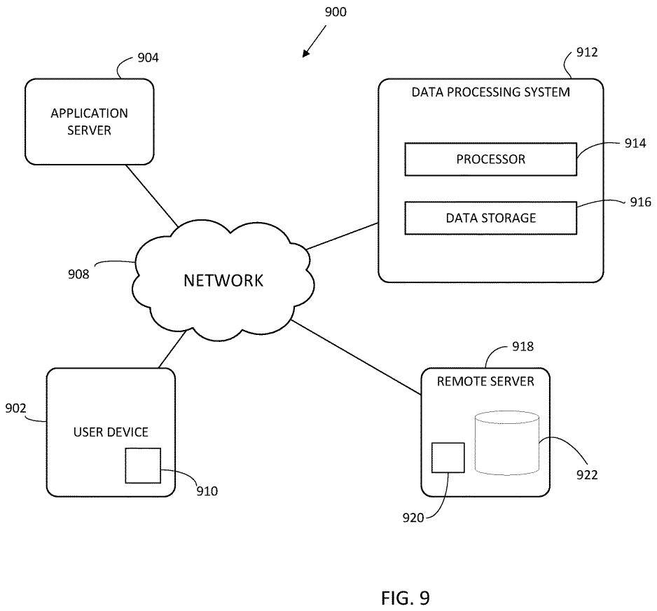

FIG. 9 depicts a block diagram of a system 900 useable with the methods of FIGS. 1-8 for providing users with a recommendation for a product or service expected to address the need or needs of a traveler. The system 900 may include a user device 902, an application server 904, a data processing system 912, and a remote server 918. The various components of the system 900 may be in communication with each other and connected by a network 908. The user device 902, the application server 904, the data processing system 912, and/or the remote server 918 may include a processing circuit or processing circuitry configured to facilitate performing the methods of FIGS. 1-8.

The user device 902 may be any suitable computing device capable of accessing and communicating using the network 908. The user device 902 may include a graphical user interface 910. The data processing system 912 may include a processor 914 and a data storage element 916 for storing instructions. The remote server 918 may be selectively accessible by the user device 902, the application server 904, and/or the data processing system 912 using an API 920. The remote server 918 may contain a remote server database 922 containing specific information pertaining to various topics.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instructions execution. Each processor may be implemented as one or more general-purpose processors, application-specific integrated circuits (ASICs), field-programmable gate arrays (FPGAs), digital signal processors (DSPs), or other suitable electronic data processing components structured to execute instructions provided by memory. The one or more processors may take the form of a single-core processor, multi-core processor (e.g., a dual-core processor, triple-core processor, quad-core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

An exemplary system for implementing the overall system or portions of the embodiments might include a general-purpose computing in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method processes, it is understood that the order of these processes may differ from what is depicted. For example, two or more processes may be performed concurrently or with partial concurrence. Also, some method processes that are performed as discrete processes may be combined, processes being performed as a combined process may be separated into discrete processes, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching processes, correlation processes, comparison processes and decision processes.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A computer-implemented method to generate a recommendation for a product or service to a user, the method comprising:
receiving data associated with travel of a traveler, the data including a travel destination, an approximate or exact travel timing, and one or more of a traveler name, a traveler age, a traveler gender identity, a traveler location, a travel departure location, a travel arrival location, a traveler distance to the travel departure location, a traveler distance to the travel arrival location, financial information of the traveler, previous trips of the traveler, an indication of whether the travel is for business or pleasure, or a traveler-indicated special need;
determining travel destination weather based at least in part on the data;
determining a likelihood the traveler has a need or needs based at least in part on the data and the travel destination weather;
generating a recommendation for a product or service expected to address the need or needs of the traveler based at least in part on the likelihood the traveler has the need or needs; and
presenting the recommendation to the user through a graphical user interface.

2. The computer-implemented method of claim 1, wherein determining the travel destination weather is performed via a weather API that communicates with an external computing system.

3. The computer-implemented method of claim 1, wherein receiving the data is performed by connecting to at least one of an enterprise resource planning application, a customer relationship management application, or an eCommerce application.

4. The computer-implemented method of claim 1, wherein the product or service comprises a commonly forgotten travel item, the computer-implemented method further comprising:
accessing a list or database of commonly forgotten travel items; and
identifying a commonly forgotten travel item expected to be of interest to the traveler based at least in part on the data, the travel destination weather, and the list or database.

5. The computer-implemented method of claim 1, wherein the product or service is available for purchase at a location of a physical retailer at or near the travel departure location or the travel arrival location and the recommendation further identifies the location of the physical retailer.

6. The computer-implemented method of claim 5, further comprising providing a map and directions to the location of the physical retailer via the graphical user interface.

7. The computer-implemented method of claim 1, wherein the product or service is available for purchase online and the computer-implemented method further comprises providing a link for the user to purchase the product or service via the graphical user interface.

8. The computer-implemented method of claim 1, wherein the recommendation is based at least in part on a user-defined limit on brand, category, or price.

9. The computer-implemented method of claim 1, wherein the data is received and the recommendation is presented at least in part by a conversational chatbot.

10. The computer-implemented method of claim 1, further comprising accessing a medical API or database to obtain medical information, wherein the need or needs are a medical need or needs, and wherein the likelihood the traveler has the medical need or needs is determined based at least in part on the medical information.

11. A data-processing system comprising:
a processor; and
a data storage element storing instructions that, when executed by the processor, cause the processor to:
receive data associated with travel of a traveler, including a travel destination, an approximate or exact travel timing, and one or more of a traveler name, a traveler age, a traveler gender identity, a traveler location, a travel arrival location, a travel departure location, a traveler distance to travel departure location, a traveler distance to travel arrival location, financial information of the traveler, previous trips of the traveler, an indication of whether travel is for business or pleasure, or a traveler-indicated special need in response to a user's interaction with a graphical user interface associated with a product or service recommendation tool provided by the data-processing system;
determine travel destination weather, based at least in part on the received data;
determine a likelihood that the traveler has a need or needs, based at least in part on the data and the travel destination weather;
generate a recommendation for a product or service expected to address the need or needs of the traveler based at least in part on the likelihood the traveler has the need or needs; and
present the recommendation to the user through the graphical user interface.

12. The data-processing system of claim 11, wherein the data is received via an application running on a user device.

13. The data-processing system of claim 12, wherein the application has access to at least one enterprise resource planning application, customer relationship management application, or eCommerce application.

14. The data-processing system of claim 11, wherein the travel destination weather is determined by connecting to a weather API.

15. The data-processing system of claim 11, wherein the instructions, when executed by the processor, further cause the processor to access a medical API or database to obtain medical information, wherein the need or needs are a medical need or needs, and wherein the likelihood the traveler has the medical need or needs is determined based at least in part on the medical information.

16. The data-processing system of claim 11, wherein the data is received and the recommendation is presented at least in part using a conversational chatbot.

17. A device for generating a recommendation for a product or service to a user, the device comprising:
a processor; and
a data storage element storing instruction that, when executed by the processor, cause the processor to:
receive data associated with travel of a traveler, including a travel destination, an approximate or exact travel timing, and one or more of a traveler name, a traveler age, a traveler gender identity, a traveler location, a time before the travel commences, departure and arrival travel locations, a traveler distance to the travel departure location, a traveler distance to the travel arrival location, financial information of the traveler, an indication of whether the travel is for business or pleasure, or a traveler-indicated special need via a user interaction with the device;
determine travel destination weather based at least in part on the data;
determine a likelihood that the traveler has a need or needs based at least in part on the data and travel destination weather;
generate a recommendation of a product or service expected to address the need or needs of the traveler based at least in part on the likelihood the traveler has a need or needs; and
present the recommendation to the user through a graphical user interface.

18. The device of claim 17, wherein the device is a kiosk configured to be at an airport, bus station, or railroad station.

19. The device of claim 17, wherein the product or service is available for purchase at a location of a physical retailer at or near the travel departure location or the travel arrival location and the recommendation further identifies the location of the physical retailer.

20. The device of claim 19, further comprising: providing a map and directions to the location of the physical retailer via the graphical user interface.
